(19) United States
(12) Patent Application Publication
(10) Pub. No.: US 2013/0322088 A1
(43) Pub. Date: Dec. 5, 2013

(54) Large-Angle Lens and Large-Angle Emission LED Light Source Module

(71) Applicants: Yangcheng HUANG, FoShan (CN); Cuie WEI, FoShan (CN); Guilin WANG, FoShan (CN); Weixian LU, FoShan (CN); Changqing WU, FoShan (CN); Shunguo HUANG, FoShan (CN)

(72) Inventors: Yangcheng HUANG, FoShan (CN); Cuie WEI, FoShan (CN); Guilin WANG, FoShan (CN); Weixian LU, FoShan (CN); Changqing WU, FoShan (CN); Shunguo HUANG, FoShan (CN)

(73) Assignee: FOSHAN NATIONSTAR OPTOELECTRONICS CO., LTD., FoShan (CN)

(21) Appl. No.: 13/604,987

(22) Filed: Sep. 6, 2012

(30) Foreign Application Priority Data
Jun. 5, 2012 (CN) 201210183866.1

(51) Int. Cl. F21V 5/04

(52) U.S. Cl. 362/311.02; 362/335

(57) ABSTRACT

Disclosed is a large-angle LED lens including a main body which has an incident surface on the inner side of the main body and an exit surface on the outer side thereof. The surfaces are provided symmetrically about the central axis of the main body. The incident and exit surfaces are transparent concave and convex surfaces, respectively. The maximum thickness d1 of the main body at the lower part and the minimum thickness d2 thereof at the top satisfy the relation: 4<d1/d2<6; the concave depth h1 of the concave surface and the thickness d2 satisfy the relation: h1>4*d2; and the convex height h2 of the convex surface and the thickness d2 satisfy the relation: h2>5*d2. With the disclosure, the light-emitting angle is increased while maximizing the utilization of the light. A large-angle emission LED light source module is also disclosed herein.

The present application claims the benefit of priority to Chinese patent application No. 201210183866.1 titled “LARGE-ANGLE LENS AND LARGE-ANGLE EMISSION LED LIGHT SOURCE MODULE”, filed with the Chinese State Intellectual Property Office on Jun. 5, 2012. The entire disclosures thereof are incorporated herein by reference.

### STATEMENT REGARDING FEDERALLY SPONSORED RESEARCH OR DEVELOPMENT

Not applicable.

### BACKGROUND

1. Field of the Invention

The present disclosure relates to the field of LED encapsulation technology, and in particular to a large-angle lens and a large-angle emission LED light source module provided with the large-angle lens.

2. Background of the Technology

The LED light source has been paid attention to and applied widely at present due to its numerous advantages, such as small volume, low power consumption, long service life, high brightness and small heat. Therefore, the LED light source technique has been rapidly developed, and efforts have been made to enhance various performances of the LED light source through technical improvement.

The LED light source has a light distribution curve approximately conformable to a Lambertian distribution, a light beam angle of about 110°˜120°, and is able to be applied in the common lighting occasion. However, the light beam angle is not large enough, and the utilization efficiency of the light energy is not high. To solve this technical problem, a secondary light distribution lens is used on the LED device in the LED light source module, and the emission angle is widened by designing the shape of the incident surface and the exit surface of the lens, so as to utilize the light energy effectively. In existing lens techniques, the effect of the light energy distribution and utilization is not very good. As such, the technical problem to be solved presently in the prior art is how to further optimize the design of the incident surface and the exit surface of the lens to further improve the emission angle of the lens.

### SUMMARY OF THE DISCLOSURE

In view of this, an object of the disclosure is to provide a large-angle lens, which may improve the light-emitting angle; and based on this, the disclosure further provides a large-angle emission LED light source module provided with this large-angle lens.

To solve the above technical problems, technical solutions of the disclosure are as follows.

A large-angle LED lens includes a shell-shaped main body with an opening at the lower end. The main body has an incident surface on the inner side of the main body and an exit surface on the outer side of the main body. Both of the incident surface and the exit surface are provided symmetrically about the central axis of the main body, the incident surface being a transparent concave surface, and the exit surface being a transparent convex surface. The maximum thickness d1 of the main body at the lower part and the minimum thickness d2 of the main body at the top satisfy the relation: 4<d1/d2<6; the concave depth h1 of the transparent concave surface and the minimum thickness d2 of the main body at the top satisfy the relation: h1>4*d2; and the convex height h2 of the transparent convex surface and the minimum thickness d2 of the main body at the top satisfy the relation: h2>5*d2.

Preferably, at the top of the main body the transparent concave surface includes a flat surface or a convex surface bulging toward the outside of the main body, and at the top of the main body the transparent convex surface includes a flat surface, or a concave surface recessing the wall of the main body, or a convex surface bulging toward the outside of the main body. In this technical solution, the following several combinations are included: 1) at the top of the main body the transparent concave surface includes a flat surface, and at the top of the main body the transparent convex surface includes a flat surface; 2) at the top of the main body the transparent concave surface includes a flat surface, and at the top of the main body the transparent convex surface includes a convex surface bulging toward the outside of the main body; 3) at the top of the main body the transparent concave surface includes a convex surface bulging toward the outside of the main body, and at the top of the main body the transparent convex surface includes a flat surface; 4) at the top of the main body the transparent concave surface includes a convex surface bulging toward the outside of the main body, and at the top of the main body the transparent convex surface includes a convex surface bulging toward the outside of the main body; 5) at the top of the main body the transparent concave surface includes a convex surface bulging toward the outside of the main body, and at the top of the main body the transparent convex surface includes a concave surface recessing the wall of the main body; and 6) at the top of the main body the transparent concave surface includes a flat surface, and at the top of the main body the transparent convex surface includes a concave surface recessing the wall of the main body.

Preferably, at the lower part of the main body the transparent convex surface includes a cylindrical surface, or a curved surface with a generating line being an arc.

Preferably, at the lower part of the main body the transparent concave surface includes a cylindrical surface, or a curved surface with a generating line being a concave function curve. The concave function curve has a slope increasing gradually from down to up.

Preferably, the thickness of the main body gradually decreases from the lower part of the main body to the top of the main body.

Preferably, a mounting part is provided at the lower end of the main body, and the bottom of the mounting part being in contact with a substrate is provided with raised stripes.

Preferably, a mounting part is provided at the lower end of the main body. The mounting part includes a first mounting part located under the transparent convex surface and a second mounting part located under the transparent concave surface. The first mounting part is of a stepped structure extending from the lower end of the outer side of the main body in a direction away from the central axis of the main body, and the second mounting part is of a concave structure extending from the lower end of the inner side of the main body in a direction away from the central axis of the main body.

A large-angle emission LED light source module provided by the disclosure includes a substrate, at least one LED device provided on the substrate, a large-angle lens covering the LED device, and a plastic housing directly formed on the substrate for encapsulating the large-angle lens and the substrate, wherein the exit surface of the large-angle lens is exposed outside the plastic housing, the large-angle lens includes a shell-shaped main body with an opening at the lower end, the main body has an incident surface on the inner side of the main body and the exit surface on the outer side of the main body, both of the incident surface and the exit surface are provided symmetrically about the central axis of the main body, the incident surface is a transparent concave surface, the exist surface is a transparent convex surface, the maximum thickness d1 of the main body at the lower part and the minimum thickness d2 of the main body at the top satisfy the relation: 4<d1/d2<6; the concave depth h1 of the transparent concave surface and the minimum thickness d2 of the main body at the top satisfy the relation: h1>4*d2; and the convex height h2 of the transparent convex surface and the minimum thickness d2 of the main body at the top satisfy the relation: h2>5*d2.

Preferably, the large-angle lens clings to the surface of the substrate tightly for covering the entire light-emitting surface of the LED device, and the plastic housing is formed on the upper surface of the substrate and around the substrate by die-casting or injection molding, so as to encapsulate the large-angle lens and the substrate.

Preferably, a mounting part is provided at the lower end of the main body, and the lower end of the mounting part is in contact with the substrate. The mounting part includes a first mounting part located under the transparent convex surface and a second mounting part located under the transparent concave surface. The first mounting part is of a stepped structure extending from the lower end of the outer side of the main body in a direction away from the central axis of the main body, and the second mounting part is of a concave structure extending from the lower end of the inner side of the main body in a direction away from the central axis of the main body.

Preferably, the substrate is a metal core PCB plate.

Preferably, the plastic housing is formed with an open groove surrounding the large-angle lens. The exit surface of the large-angle lens is exposed out of the bottom surface of the groove, and the side surfaces of the open groove are inclined with respect to the bottom surface of the open groove.

Preferably, the side surfaces of the open groove are at an angle of 10°˜52° with respect to the bottom surface of the open groove.

Preferably, the large-angle lens and the plastic housing are formed integrally.

Compared with the prior art, with the large-angle lens of the disclosure, the shapes of the transparent concave surface of the incident surface and the transparent convex surface of the exit surface are optimized, and the thicknesses at different parts of the main body are set, and the relations between the thickness of the top of the main body, the depth of the transparent concave surface and the height of the transparent convex surface are optimized, so that the light-emitting angle of the lens is improved significantly, and the light beam angle can be converted to be larger than 130°, thereby achieving the large-angle lighting while improving the lighting evenness; the designs of the transparent concave surface and the transparent convex surface minimize the probability of the total reflection, so that the increased light-emitting angle is ensured while ensuring the efficiency of the lens up to 90%, thereby maximizing the utilization of the light.

Further, in actual application, this structural arrangement of the mounting part located at the lower end of the main body can protect the LED device well. The lens covers the LED light-emitting surface, so that the LED device is protected better from being influenced by the external environment, thereby prolonging the service life of the device.

The large-angle lens of the disclosure applied to the LED light source module can increase the light-emitting angle of the entire LED light source module, thereby enlarging the illuminating area of the LED light source module. Thus, in practical application in the terminal, the arranging density of the LED light source module can be decreased, and the number of the LED light source module in use can be decreased, so that the labor mounting cost of the terminal and the production cost are decreased.

### BRIEF DESCRIPTION OF THE DRAWINGS

FIG. 1 is a longitudinal sectional view of a large-angle lens of a first embodiment according to the disclosure;

FIG. 2 is a schematic diagram of the overall structure of the large-angle lens in FIG. 1;

FIG. 3 is another schematic diagram of the overall structure of the large-angle lens in FIG. 1;

FIG. 4 is a schematic diagram of light paths of the large-angle lens in FIG. 1;

FIG. 5 is a longitudinal sectional view of a large-angle lens of a second embodiment according to the disclosure;

FIG. 6 is a longitudinal sectional view of a large-angle lens of a third embodiment according to the disclosure;

FIG. 7 is a partially enlarged view of the large-angle lens in FIG. 6;

FIG. 8 is a schematic structural diagram of a large-angle emission LED light source module of a first embodiment according to the disclosure;

FIG. 9 is a longitudinal sectional view of the large-angle emission LED light source module in FIG. 8;

FIG. 10 is a sectional view of fitting between the large-angle lens and the substrate in FIG. 8;

FIG. 11 is a light curve distribution with Lambertian distribution produced by the LED light source module without the large-angle lens in FIG. 8;

FIG. 12 is a light distribution curve of the large-angle emission LED light source module in FIG. 8;

FIG. 13 is a schematic diagram of light emission of the LED light source module in use without the large-angle lens;

FIG. 14 is a schematic diagram of light emission of the LED light source module in FIG. 8 in use;

FIG. 15 is a schematic diagram of the overall structure of a large-angle emission LED light source module of a second embodiment according to the disclosure;

FIG. 16 is a longitudinal sectional view of the large-angle emission LED light source module in FIG. 15;

FIG. 17 is a schematic diagram of the overall structure of a large-angle emission LED light source module of a third embodiment according to the disclosure; and

FIG. 18 is a sectional view of the large-angle emission LED light source module seeing from direction B in FIG. 17.

### DETAILED DESCRIPTION OF THE PREFERRED EMBODIMENTS

The disclosure will be described in further detail in conjunction with the drawings and the specific embodiments, in order that those skilled in the art will understand the technical solution of the disclosure better.

### First Embodiment of Large-angle Lens

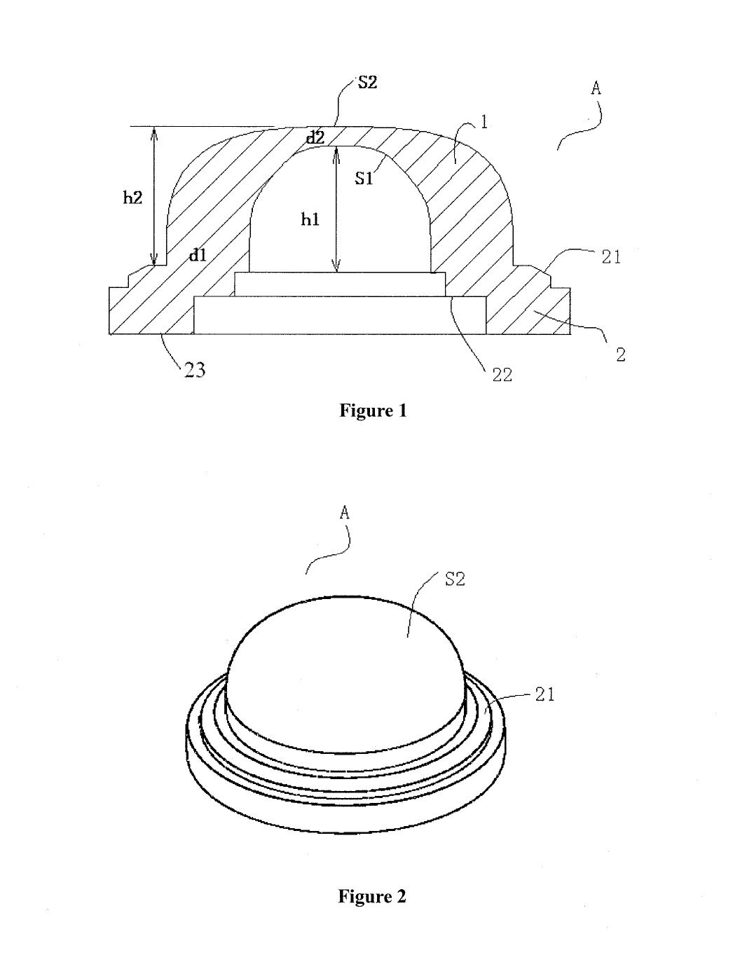

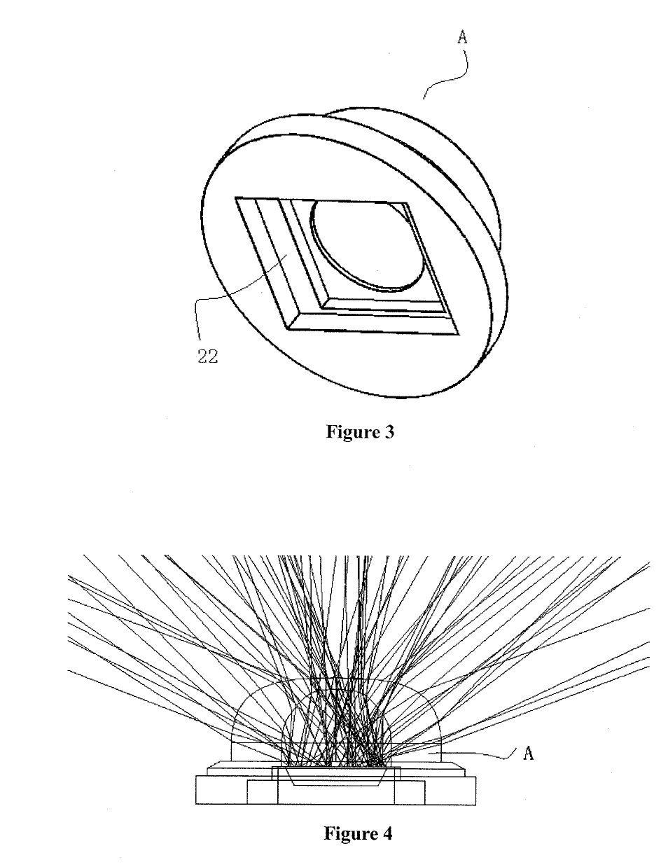

Referring to FIGS. 1, 2 and 3, a large-angle lens A of this embodiment includes a shell-shaped main body 1 with an opening at the lower end, and a mounting part 2 that is provided at the lower part of the main body 1 and molded integrally with the main body 1. The main body 1 has an incident surface S1 and an exit surface S2. The incident surface S1 and the exit surface S2 are respectively provided symmetrically about the central axis of the main body. The large-angle lens of this embodiment is made of a transparent material.

The incident surface S1 is a transparent concave surface, which changes gradually from a cylindrical surface at the lower half part into a spherical surface, and then transits into a flat surface at the top smoothly.

The exit surface S2 is a transparent convex surface, which bends gradually toward the central axis of the main body from a cylindrical surface at the lower half part, and then becomes a flat surface at the top of the main body finally.

The thickness of the main body 1 gradually decreases from down to up. The main body 1 has a cylinder shape at the lower part. The thickness d1 of the lower part of the main body 1, which is even, is defined as the horizontal distance from the incident surface S1 to the exit surface S2, being the maximum thickness of the main body; and the minimum thickness d2 (i.e., the thickness of the centre of the lens) of the top of the main body 1, which is even, is defined as the distance from the top surface of the incident surface S1 to the top surface of the exit surface S2, being the minimum thickness of the whole main body 1; wherein d1 and d2 satisfy the relation: 4<d1/d2<6.

Further, the concave depth h1 of the transparent concave surface, i.e., the distance from the bottom to the highest point on the top of the transparent concave surface S1, and the thickness d2 of the centre of the lens satisfy the relation: h1>4*d2.

The convex height h2 of the transparent convex surface, i.e., the distance from the bottom to the highest point on the top of the transparent convex surface S2, and the thickness d2 of the centre of the lens satisfy the relation: h2>5*d2.

The light paths of the large-angle lens in this embodiment is shown in FIG. 4, which is characterized in that the light rays are deflected through the two transparent surfaces, i.e., the transparent concave surface S1 and the transparent convex surface S2. In this way, the light rays are redistributed, so that more light rays are deflected from the axis, and most of the light rays passing through the lens A have an exit angle equal to or larger than the exit angle of the light rays emitted from the light-emitting surface.

Further, with the large-angle lens A of this embodiment, the increased emission angle is ensured and meanwhile the efficiency of the lens is ensured to go up to 90%, mainly because the two transparent surfaces, i.e., the transparent concave surface S1 and the transparent convex surface S2, are designed such as to minimize the probability of the total reflection and thus to maximize the utilization of the light.

Referring again to FIG. 1, the mounting part 2 includes a first mounting part 21 and a second mounting part 22. The first mounting part 21 is provided near the transparent convex surface S2 to facilitate the encapsulation of the large-angle lens and the substrate, and the second mounting part 22 is provided near the transparent concave surface S1 to facilitate the mounting and the fixing of the LED device. The first mounting part 21 is of a stepped structure that is provided outside the lens A and located at the lower part of the transparent convex surface S2. Moving downward along the first mounting part 21, the entire stepped structure includes a flat surface, an inclined surface, a vertical surface, a flat surface and a vertical surface. The second mounting part 22 is of a concave structure that is provided inside the lens A and located at the lower part of the transparent concave surface S1 of the main body 1. Moving downward along the second mounting part 22, the concave structure includes a flat surface, a vertical surface, a flat surface and a vertical surface.

In other embodiments, as a more preferred solution, several raised stripes, such as helical stripes, are provided on the bottom 23 of the mounting part 2, so that the light emitted to the bottom can be reflected back to the lens A, so as to increase the utilization of the light energy.

### Second Embodiment of Large-angle Lens

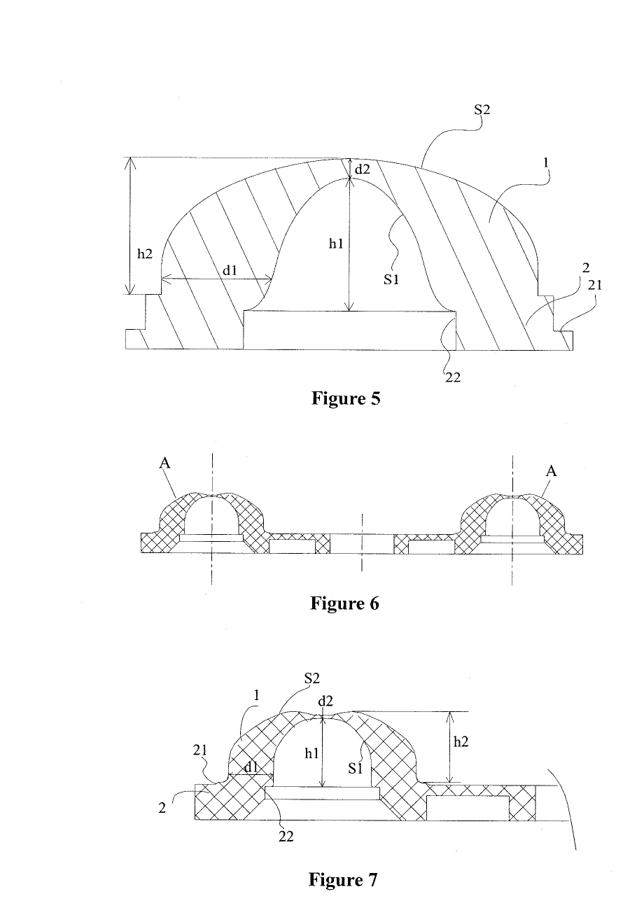

Referring to FIG. 5, the large-angle lens in this embodiment includes a main body 1 and a mounting part 2 that is provided under the main body 1. The main body 1 has an incident surface S1 and an exit surface S2 which both are provided with respect to a central axis circumferentially and symmetrically. The mounting part 2 includes a first mounting part 21 and a second mounting part 22. The first mounting part 21 is provided near the transparent convex surface S2 to facilitate the encapsulation of the large-angle lens and the substrate, and the second mounting part 22 is provided near the transparent concave surface S1 to facilitate the mounting and the fixing of the LED device.

This embodiment is different from the first embodiment in that, at the top of the main body 1 the transparent convex surface S2 includes a convex surface bulging toward the outside of the main body 1, and at the top of the main body 1 the transparent concave surface S1 includes a convex surface bulging toward the outside of the main body 1; the transparent concave surface S1 includes a curved surface at its lower part, instead of a cylindrical surface, wherein the curved surface has a generating line being a concave function curve, with a slope gradually increasing from down to up, so that the thickness of the lower part of the main body 1 is uneven. However, other conditions are still satisfied, for example, d1 and d2 still satisfy the relation: 4<d1/d2<6; the concave depth h1 of the transparent concave surface S1, i.e., the distance from the bottom to the highest point on the top of the transparent concave surface S1, and the thickness d2 of the center of the lens still satisfy the relation: h1>4*d2; and the convex height h2 of the transparent convex surface S2, i.e., the distance from the bottom to the highest point on the top of the transparent convex surface S2, and the thickness d2 of the center of the lens still satisfy the relation: h2>5*d2.

In this embodiment, the light rays are deflected through the two transparent surfaces, i.e., the transparent concave surface S1 and the transparent convex surface S2. In this way, the light rays are redistributed, so that more light rays are deflected from the axis, and most of the light rays passing through the lens have an exit angle equal to or larger than the exit angle of the light rays emitted from the light-emitting surface.

### Third Embodiment of Large-angle Lens

Referring to FIGS. 6 and 7, in this embodiment, the two large-angle lenses A are manufactured integrally, each of which includes a main body 1 and a mounting part 2 provided under the main body 1. The main body 1 has an incident surface S1 and an exit surface S2 which both are provided with respect to a central axis circumferentially and symmetrically. The mounting part 2 includes a first mounting part 21 and a second mounting part 22. The first mounting part 21 is provided near the transparent convex surface S2 to facilitate the encapsulation of the large-angle lens and the substrate, and the second mounting part 22 is provided near the transparent concave surface S1 to facilitate the mounting and the fixing of the LED device.

This embodiment is different from the first embodiment in that, the top of the transparent convex surface S2 includes a concave surface recessing the wall of the main body 1, rather than a flat surface, and the top of the transparent concave surface S1 includes a convex surface bulging outward, rather than a flat surface. However, other conditions are still satisfied, for example, d1 and d2 still satisfy the relation: 4<d1/d2<6; the concave depth h1 of the transparent concave surface S1, i.e., the distance from the bottom to the highest point on the top of the transparent concave surface S1, and the thickness d2 of the center of the lens still satisfy the relation: h1>4*d2; and the convex height h2 of the transparent convex surface S2, i.e., the distance from the bottom to the highest point on the top of the transparent convex surface S2, and the thickness d2 of the center of the lens still satisfy the relation: h2>5*d2.

In this embodiment, the light rays are deflected through the two transparent surfaces S1, S2, i.e., the transparent concave surface and the transparent convex surface. In this way, the light rays are redistributed, so that more light rays are deflected from the axis, and most of the light rays passing through the lens have an exit angle equal to or larger than the exit angle of the light rays emitted from the light-emitting surface.

In the large-angle lens in the above embodiments, the transparent convex surface S2 includes a cylindrical surface at the lower part of the main body 1. Alternatively, in other embodiments, this surface can also be provided as a curved surface which has a generating line being an arc. Further, the generating line can be a concave function curve, with a slope gradually increasing from down to up.

### First Embodiment of Large-angle Emission LED Light Source Module

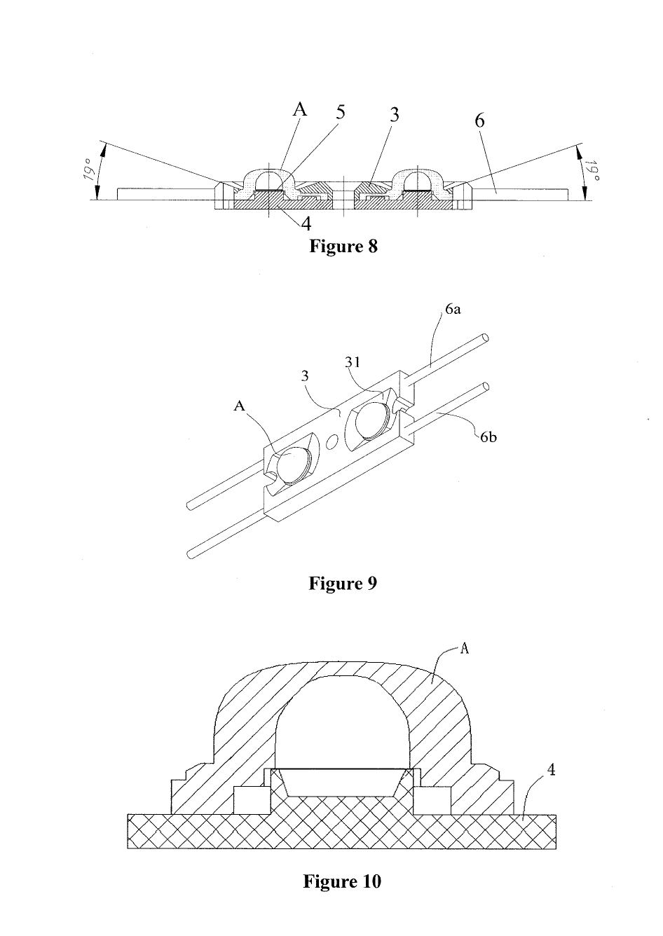

Referring to FIGS. 8, 9 and 10, the large-angle emission LED light source module of this embodiment includes a substrate 4, two LED devices 5 provided on the substrate 4, a large-angle lens A, a plastic housing 3, and a power wire 6 connected to the substrate 4. Welding positions for the power wire are provided on the upper surface of the substrate 4, and a power input wire 6a and a power output wire 6b are provided at the two long edges of the upper surface of the substrate 4 respectively, thereby achieving the connection between the substrate 4 and the external power supply. An open groove 31 is formed at the outside of the plastic housing 3, and is provided around the large-angle lens A such that the exit surface of the large-angle lens A is exposed out of the bottom surface of the open groove 31 without being covered by the plastic housing 3. The side wall of the open groove 31 is composed of four inclined flat surfaces. Among these inclined flat surfaces, the two flat surfaces along the length direction of the LED light source module each are at an angle of 19° with respect to the bottom surface of the open groove 31, or in other embodiments, this angle can also be any value within the range of 15°˜25°. The two flat surfaces along the width direction of the LED light source module each are at an angle of 49° with respect to the bottom surface of the open groove 31, or in other embodiments, this angle can also be any value within the range of 45°˜52°. This structural arrangement facilitates the emission of the light.

The bottom surface of the large-angle lens A clings to the surface of the substrate 4 tightly for covering the light-emitting surface of the LED device. The plastic housing 3 is formed of a molding material directly on the substrate 4, so as to encapsulate the large-angle lens A and the substrate 4, with the plastic housing 3 being formed on the surface of the substrate 4 and around the substrate 4 to cover the substrate 4. The forming process of the plastic housing 3 can be the injection molding or the die-casting forming process. In this embodiment, because of the large-angle lens A, the light-emitting angle is increased to 155°. The substrate 4 in this embodiment is a metal core PCB plate. In this embodiment, the molding material for the plastic housing 3 can be ABS resin. The structure of the large-angle lens A used in this embodiment is identical to that of the large-angle lens of the above first embodiment.

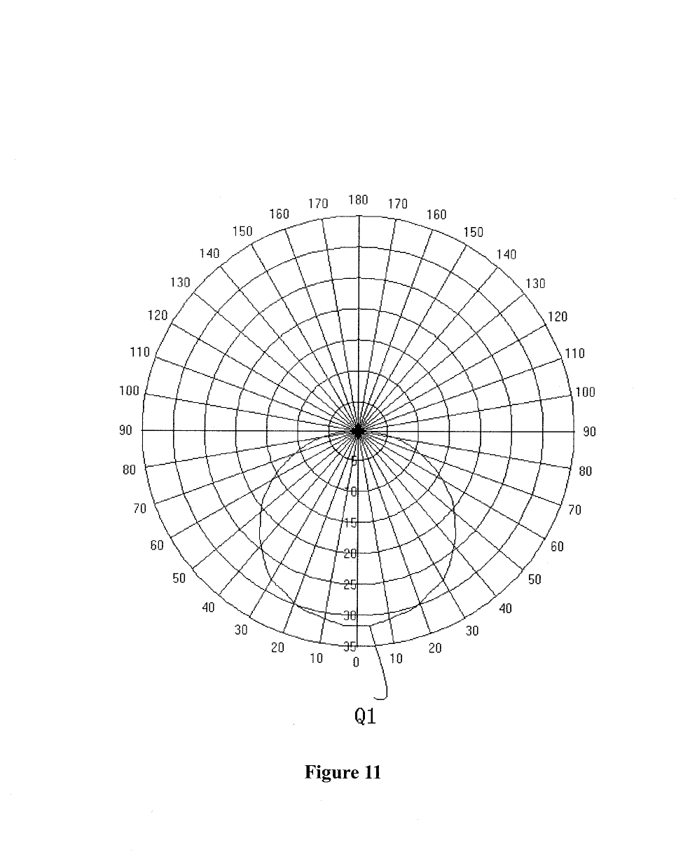

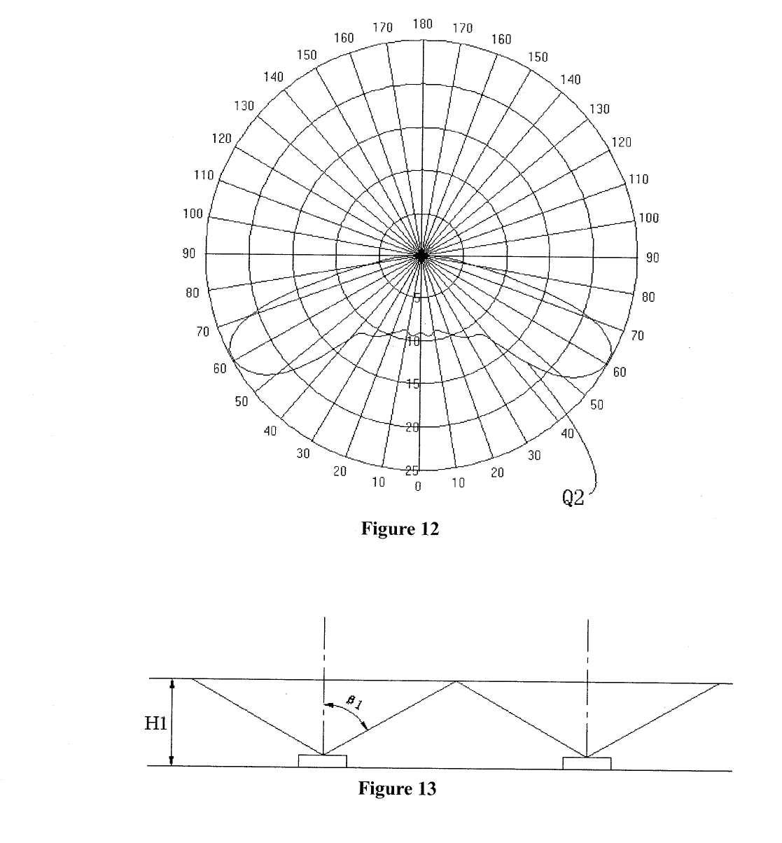

Referring to FIG. 11, if no large-angle lens is provided, the light distribution curve Q1 of the LED light source module conforms to a Lambertian distribution, as the curve Q1 is similar to a circle in the figure, in which the light beam angle is 110˜120°, and the parameters related to the emission of light are as follows: the efficiency is 1.0000-100000 light rays; the minimum of the light intensity is 4.8113e-013 cd; the maximum of the light intensity is 31.683 cd; and the total flux is 1001 m. As shown in FIG. 12, the LED light source module with the large-angle lens in this embodiment has a light distribution curve being a bat wing shaped distribution curve Q2, in which the light beam angle is 130°˜155°, and the parameters related to the emission of light are as follows: the efficiency is 0.90246-99572 light rays; the minimum of the light intensity is 2.5724e-013 cd; the maximum of the light intensity is 24.87 cd; and the total flux is 90.2461 m. Compared with the Lambertian distribution curve, such a bat wing shaped light distribution curve Q2 is more prone to achieve evenness of the lighting.

As shown in FIG. 13, before the large-angle lens is added, the light-emitting angle of the LED light source module itself is β1, and in practice, the height of H1 has to be obtained to ensure the evenness of the brightness of the light-emitting surface.

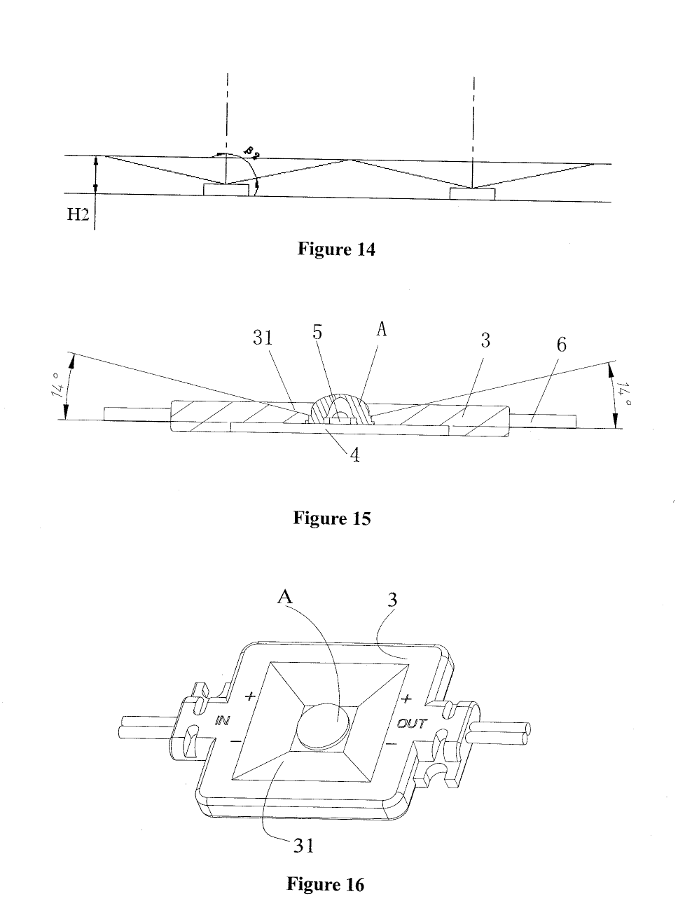

The light-emitting angle of the LED light source module is increased to β2 by incorporating the large angle lens, so that the height of the light-emitting surface may be decreased to H2 while ensuring the uniform brightness of the light-emitting surface, as shown in FIG. 14. In this way, the practical height in actual application can be decreased, thereby saving the cost. On the other hand, the number of the LED light source modules used can be decreased in the event that the height is not decreased in actual application, thereby reducing the number of the production components and the labor cost for mounting.

In this embodiment, the LED device and the large-angle lens are enclosed by a plastic housing, thereby achieving the good moisture-proof and corrosion-proof performance, relieving the aging of the module, and satisfying the exhibition requirement in outdoor complex environment.

### Second Embodiment of Large-angle Emission LED Light Source Module

Referring to FIGS. 15 and 16, this embodiment is different from the previous embodiment in that the large-angle lens A used has a different structure. The lens A adopted in this embodiment is of a lens structure of the large-angle lens in the second embodiment described above. Additionally, the inclined angle of the side wall flat surfaces of the open groove 31 in the plastic housing is different between this embodiment and the previous embodiment. The flat surfaces of the side wall of the open groove 31 in this embodiment each are at the same angle of 14° with respect to the bottom surface of the open groove. Alternatively, in other embodiments, this angle can also be any value within the range of 10°˜16°.

### Third Embodiment of Large-angle Emission LED Light Source Module

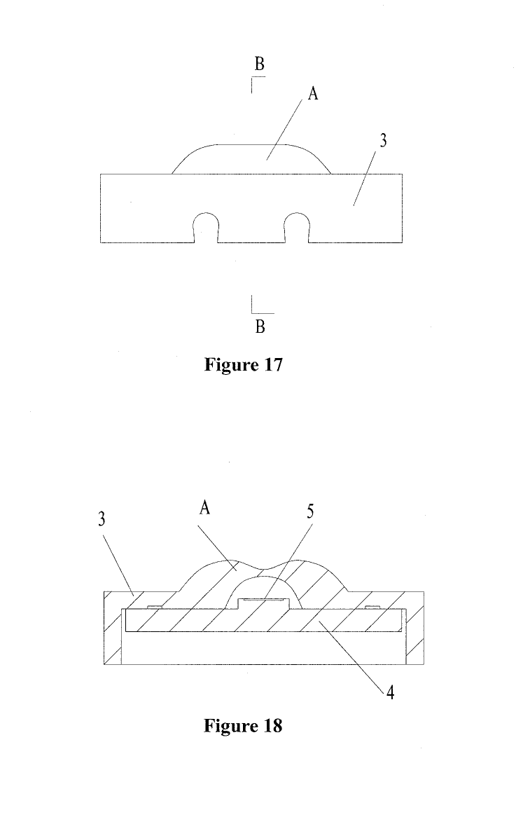

Referring to FIGS. 17 and 18, the difference between this embodiment and the above two embodiments lies in that, in this embodiment, the plastic housing 3 and the large-angle lens A are integrally manufactured with the same material through an integral forming process. In such an integral structure of the large-angle lens A and the plastic housing 3, the LED device 5 is encapsulated on the substrate 4.

Preferably, the plastic housing 3 and the large-angle lens A are made of the water-proof material.

Preferably, the light-emitting surface of the large-angle lens A is a frosted surface.

The structure of the large-angle lens A in this embodiment is similar to the structure of the large-angle lens in the third embodiment described above, in which the top of the transparent convex surface S2 includes a concave surface recessing the wall of the main body 1 rather than a flat surface, and the top of the transparent concave S1 surface includes a curved surface bulging outward rather than a flat surface.

The disclosure has been described in detail above, and specific examples are adopted to describe the principle and the embodiment of the disclosure. The description of the above embodiments is only used to help understand the method of the disclosure and the core idea thereof. It should be noted that several modifications and improvements can be made by those skilled in the art without departing from the principle of the disclosure, and these modifications and improvements should be considered as falling within the scope of protection of the disclosure claimed in claims.

What is claimed is:

1. A large-angle LED lens, comprising:
a shell-shaped main body with an opening at a lower end and a top, the main body further having an incident surface on an inner side of the main body and an exit surface on an outer side of the main body, both of the incident surface and the exit surface being provided symmetrically about a central axis of the main body, the incident surface being a transparent concave surface, the exit surface being a transparent convex surface;
wherein a maximum thickness d1 of the main body at a lower part and a minimum thickness d2 of the main body at the top satisfy the relation: 4<d1/d2<6;
wherein a concave depth h1 of the transparent concave surface and the minimum thickness d2 of the main body at the top satisfy the relation: h1>4*d2; and
wherein a convex height h2 of the transparent convex surface and the minimum thickness d2 of the main body at the top satisfy the relation: h2>5*d2.

2. The large-angle LED lens according to claim 1, wherein at the top of the main body the transparent concave surface comprises a flat surface or a convex surface bulging toward the outer side of the main body, and at the top of the main body the transparent convex surface comprises a flat surface, or a concave surface recessing a wall of the main body, or a convex surface bulging toward the outside of the main body.

3. The large-angle LED lens according to claim 1, wherein at the lower part of the main body the transparent convex surface comprises a cylindrical surface, or a curved surface with a generating line being an arc.

4. The large-angle LED lens according to claim 1, wherein at the lower part of the main body the transparent concave surface comprises a cylindrical surface, or a curved surface which has a generating line being a concave function curve, and wherein the concave function curve has a slope increasing gradually from the lower part toward the top.

5. The large-angle LED lens according to claim 1, wherein a thickness of the main body gradually decreases from the lower part of the main body to the top of the main body.

6. The large-angle LED lens according to claim 1, wherein a mounting part is provided at the lower end of the main body, and a bottom of the mounting part is in contact with a substrate provided with raised stripes.

7. The large-angle LED lens according to claim 1, wherein a mounting part is provided at the lower end of the main body, the mounting part including a first mounting part located under the transparent convex surface and a second mounting part located under the transparent concave surface, the first mounting part is of a stepped structure extending from a lower end of the outer side of the main body in a direction away from the central axis of the main body, and the second mounting part is of a concave structure extending from a lower end of the inner side of the main body in a direction away from the central axis of the main body.

8. A large-angle emission LED light source module, comprising:
a substrate;
at least one LED device provided on the substrate;
a large-angle lens covering the LED device; and
a plastic housing directly formed on the substrate for encapsulating the large-angle lens and the substrate;
wherein an exit surface of the large-angle lens is exposed out of the plastic housing, and the large-angle lens comprises a shell-shaped main body with an opening at a lower end, the main body comprising:
an incident surface on an inner side of the main body and an exit surface on an outer side of the main body, both of the incident surface and the exit surface are provided symmetrically about a central axis of the main body, the incident surface being a transparent concave surface, the exist surface being a transparent convex surface;
a maximum thickness d1 of the main body at a lower part;
a minimum thickness d2 of the main body at the top;
wherein d1 and d2 satisfy the relation: 4<d1/d2<6;
a concave depth h1 of the transparent concave surface and the minimum thickness d2 of the main body at the top satisfy the relation: h1>4*d2; and
a convex height h2 of the transparent convex surface and the minimum thickness d2 of the main body at the top satisfy the relation: h2>5*d2.

9. The large-angle emission LED light source module according to claim 8, wherein the large-angle lens is coupled to a surface of the substrate tightly to cover the entire light-emitting surface of the LED device, and wherein the plastic housing is formed on an upper surface of the substrate and around the substrate by die-casting or injection molding, so as to encapsulate the large-angle lens and the substrate.

10. The large-angle emission LED light source module according to claim 8, wherein a mounting part is provided at the lower end of the main body, a lower end of the mounting part is in contact with the substrate, the mounting part comprising:
a first mounting part located under the transparent convex surface; and
a second mounting part located under the transparent concave surface;
wherein the first mounting part is of a stepped structure extending from a lower end of the outer side of the main body in a direction away from the central axis of the main body, and the second mounting part is of a concave structure extending from a lower end of the inner side of the main body in a direction away from the central axis of the main body.

11. The large-angle emission LED light source module according to claim 8, wherein the substrate is a metal core PCB plate.

12. The large-angle emission LED light source module according to claim 8, wherein the plastic housing is formed with an open groove surrounding the large-angle lens, the exit surface of the large-angle lens is exposed out of a bottom surface of the groove, and side surfaces of the open groove are inclined with respect to the bottom surface of the open groove.

13. The large-angle emission LED light source module according to claim 12, wherein the side surfaces of the open groove are at an angle of 10°˜52° with respect to the bottom surface of the open groove.

14. The large-angle emission LED light source module according to claim 8, wherein the large-angle lens and the plastic housing are formed integrally.
